(19) United States
(12) Patent Application Publication
(10) Pub. No.: US 2002/0153353 A1
(43) Pub. Date: Oct. 24, 2002

(54) Vacuum valve

(75) Inventors: Kouichi Inagaki, Tokyo (JP); Norio Kan, Tokyo (JP); Takakazu Harada, Tokyo (JP)

Correspondence Address: SUGHRUE, MION, ZINN, MACPEAK & SEAS, 2100 Pennsylvania Avenue, N.W., Washington, DC, 20037, US

(73) Assignee: MITSUBISHI DENKI KABUSHIKI KAISHA

(21) Appl. No.: 10/038,826

(22) Filed: Jan. 8, 2002

(30) Foreign Application Priority Data
Apr. 19, 2001 (JP) 2001-121196

(51) Int. Cl. H01H 33/66

(52) U.S. Cl. 218/118

(57) ABSTRACT

A vacuum valve includes a vacuum vessel having an interior portion sealed by a fixed-end end plate and a moving-end end plate disposed at first and second end portions, respectively, of a cylindrical electrically-insulating tube, a fixed electrode rod secured to the fixed-end end plate, a fixed electrode being disposed on an end portion of the fixed electrode rod, a movable electrode rod, a movable electrode capable of contacting and separating from the fixed electrode being disposed on an end portion of the movable electrode rod, and an electrode shield secured to the electrically-insulating tube and enveloping the fixed electrode and the movable electrode, the electrode shield preventing an inner wall surface of the electrically-insulating tube from being polluted by a metallic vapor generated by the fixed electrode and the movable electrode during electric-current interruption, a recess portion being formed in a central portion of only one of either a contact surface of the movable electrode or a contact surface of the fixed electrode.

### BACKGROUND OF THE INVENTION

1. Field of the Invention

The present invention relates to a vacuum valve and particularly to an electrode construction for a vacuum valve.

2. Description of the Related Art

FIG. 8 is a cross section showing a conventional vacuum valve as disclosed in Japanese Patent Laid-Open No. 09-320412, for example.

The vacuum valve in FIG. 8 includes: a cylindrical electrically-insulating tube 1 constituted by an alumina ceramic or the like; a fixed-end end plate 2; and a moving-end end plate 3, the fixed-end end plate 2 and the moving-end end plate 3 each being mounted coaxially by brazing to first and second ends of the electrically-insulating tube 1. Assembly is mainly performed using a silver-base brazing filler material, a fixed electrode rod 4 being joined by brazing to the fixed-end end plate 2, and a movable electrode rod 5 being joined by brazing to the moving-end end plate 3 by means of a bellows 6. A fixed electrode 7 is joined by brazing to an end portion of the fixed electrode rod 4, and a movable electrode 8 is joined by brazing to an end portion of the movable electrode rod 5, the fixed electrode 7 and the movable electrode 8 being disposed so as to face each other.

The bellows 6 is made into an accordion shape from a thin stainless steel sheet, enabling the movable electrode rod 5 to move while remaining airtight. An electrode shield 9 is secured to the electrically-insulating tube 1, the electrode shield 9 being disposed so as to surround the fixed electrode 7 and the movable electrode 8, and a bellows shield 10 is disposed so as to cover the bellows 6, the electrode shield 9 and the bellows shield 10 preventing an inner surface of the electrically-insulating tube 1 and the bellows 6 from being polluted by a metallic vapor generated by the fixed electrode 7 and the movable electrode 8 during electric-current interruption.

A guide mount plate 11 is disposed on the moving-end end plate 3, and a resin guide 12 guides movement of the movable electrode rod 5. The resin guide 12 is mounted to the guide mount plate 11 by a screw, etc., (not shown) after completion of assembly of the vacuum valve by brazing.

A switching operation of the vacuum valve of the above construction is performed by the operation of a circuit breaker actuator mechanism mounted to an end portion of the movable electrode rod 5, but misalignment can arise between the central axes of the fixed electrode rod 4 and the movable electrode rod 5 due to factors such as tolerances in parts of the actuator mechanism.

Since the actuator mechanism simultaneously converts three phase rotational motions on an axle into rectilinear motion by a lever, the action of the movable electrode rod 5 of the vacuum valve during switching has a slightly curved motion. For that reason, a slight clearance between the resin guide 12 and the movable electrode rod 5 is designed to reduce friction so that the movable electrode rod 5 operates smoothly, and a certain amount of tilting may arise in the movable electrode 8 during contact making or breaking in the vacuum valve.

It is necessary for the vacuum valve to simultaneously satisfy performance conditions such as: a) a large interrupting capacity for large currents; b) a good withstand voltage; c) a low weld release force; d) a long service life with a low electrode wear rate; and e) a low, stable contact resistance, etc., but compactness and low cost are also in demand.

In order to improve large-current interrupting capacity when short-circuit interrupting performance at 20 kA or more is required, improvement of interrupting performance has generally been attempted by disposing spiral grooves in the electrodes to drive an electric arc during electric-current interruption, or by disposing coil electrodes on a rear side of the electrodes to create a diffuse arc.

On the other hand, in cases of 16 kA or less, the most economical method has been to use a material having a high interrupting capacity for the electrode material itself in a simple flat construction, rather than use a complex construction.

Short-circuit current-making performance and short-time withstand current performance are required, but since arcs form and welding occurs due to the generation of heat during electrification in conventional vacuum valves in such cases, large actuating forces have been required to release the electrodes 7 and 8 from each other.

Performance such as that above is required in conventional vacuum valves but as actuating forces for releasing the electrodes 7 and 8 from each other increase, strength improvements are required in the actuator mechanism of the circuit breaker, and one problem has been that valves have been become proportionately more expensive.

### SUMMARY OF THE INVENTION

The present invention aims to solve the above problems and an object of the present invention is to economically provide a vacuum valve simultaneously providing a combination of good performance characteristics including a large-current interruption capacity, a reduced weld release force, a low, stable contact resistance, and a reduced electrode wear rate.

In order to achieve the above object, according to one aspect of the present invention, there is provided a vacuum valve including:

a vacuum vessel having an interior portion sealed by a fixed-end end plate and a moving-end end plate disposed at first and second end portions, respectively, of a cylindrical electrically-insulating tube;

a fixed electrode rod secured to the fixed-end end plate, a fixed electrode being disposed on an end portion of the fixed electrode rod;

a movable electrode rod, a movable electrode capable of contacting and separating from the fixed electrode being disposed on an end portion of the movable electrode rod; and

an electrode shield secured to the electrically-insulating tube and enveloping the fixed electrode and the movable electrode, the electrode shield preventing an inner wall surface of the electrically-insulating tube from being polluted by a metallic vapor generated by the fixed electrode and the movable electrode during electric-current interruption,

a recess portion being formed in a central portion of only one of either a contact surface of the movable electrode or a contact surface of the fixed electrode.

In the vacuum valve according to the present invention, the recess portion may be formed only on the fixed electrode.

According to another aspect of the present invention, there is provided a vacuum valve including:

a vacuum vessel having an interior portion sealed by a fixed-end end plate and a moving-end end plate disposed at first and second end portions, respectively, of a cylindrical electrically-insulating tube;

a fixed electrode rod secured to the fixed-end end plate, a fixed electrode being disposed on an end portion of the fixed electrode rod;

a movable electrode rod, a movable electrode capable of contacting and separating from the fixed electrode being disposed on an end portion of the movable electrode rod; and

a fixed-end shield secured to the fixed-end end plate and enveloping the fixed electrode and the movable electrode, the fixed-end shield preventing an inner wall surface of the electrically-insulating tube from being polluted by a metallic vapor generated by the fixed electrode and the movable electrode during electric-current interruption,

a recess portion being formed in a central portion of only a contact surface of the fixed electrode.

According to yet another aspect of the present invention, there is provided a vacuum valve including:

a vacuum vessel having an interior portion sealed by a fixed-end end plate and a moving-end end plate disposed at first and second end portions, respectively, of a cylindrical electrically-insulating tube;

a fixed electrode rod secured to the fixed-end end plate, a fixed electrode being disposed on an end portion of the fixed electrode rod;

a movable electrode rod, a movable electrode capable of contacting and separating from the fixed electrode being disposed on an end portion of the movable electrode rod; and

a moving-end shield secured to the moving-end end plate and enveloping the fixed electrode and the movable electrode, the moving-end shield preventing an inner wall surface of the electrically-insulating tube from being polluted by a metallic vapor generated by the fixed electrode and the movable electrode during electric-current interruption,

a recess portion being formed in a central portion of only a contact surface of the movable electrode.

### BRIEF DESCRIPTION OF THE DRAWINGS

FIG. 1 is a cross section showing a vacuum valve according to Embodiment 1 of the present invention;

FIG. 2 is an enlarged cross section of the vicinity of electrodes of a conventional vacuum valve;

FIG. 3 is an enlarged cross section of the vicinity of electrodes of the vacuum valve according to Embodiment 1 of the present invention;

FIG. 4 is a cross section showing a vacuum valve according to Embodiment 2 of the present invention;

FIG. 5 is a cross section showing a conventional vacuum valve;

FIG. 6 is a cross section showing a vacuum valve according to Embodiment 3 of the present invention;

FIG. 7 is a cross section showing a vacuum valve according to Embodiment 4 of the present invention; and

FIG. 8 is another cross section showing a conventional vacuum valve.

### DETAILED DESCRIPTION OF THE PREFERRED EMBODIMENTS

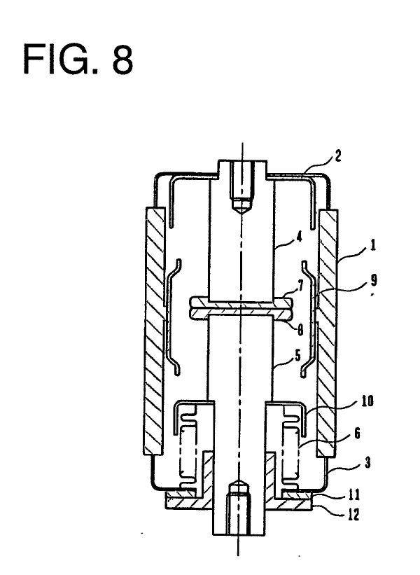

The preferred embodiments of the present invention will be explained below based on the drawings. Moreover, members and portions the same as or equivalent to those in the conventional vacuum valve shown in FIG. 8 will be allocated the same numbering, and explanation thereof will omitted.

Embodiment 1

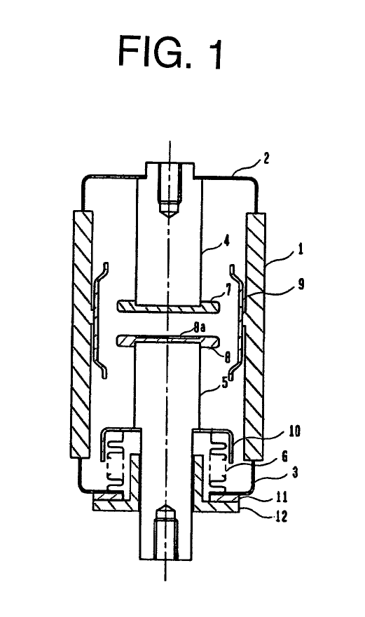

FIG. 1 is a cross section showing a vacuum valve according to Embodiment 1 of the present invention. A recess portion 8a is formed in a central portion of a contact surface of the movable electrode 8.

Next, the electrical performance of the vacuum valve according to Embodiment 1 will be explained.

First, weld release during short-circuit current making and short-time withstand current will be explained.

Since the electric current forms a concentrated arc, welding imprints due to premature arcing during short-circuit current making and welding imprints from arc formation during short-time withstand current are not formed over the entire contact surface of the electrodes 7 and 8, but instead a welding imprint having an extremely small surface area compared to the surface area of the electrodes 7 and 8 is generated usually in just a single position within the locality of electric arc formation.

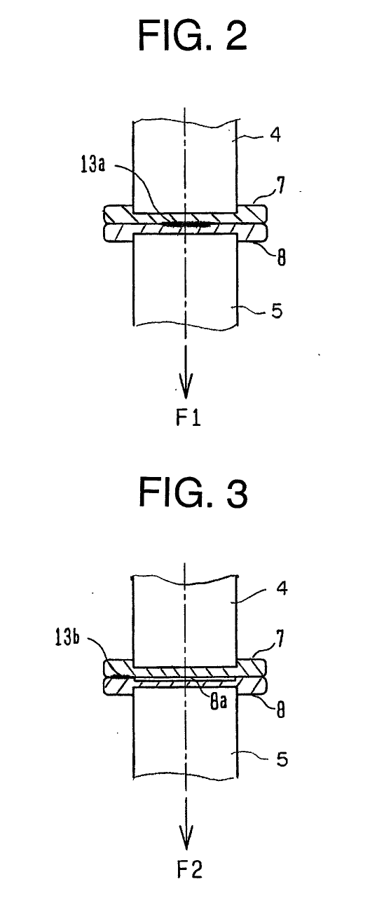

FIG. 2 is an enlargement of the vicinity of the electrodes 7 and 8 of a conventional example. Welding positions 13a during making and during short-time withstand current are shown. In this case, since the entire contact surface is flat, when welding imprints are generated in a central portion, a load of F1 is required as the force necessary to release the electrodes 7 and 8 from each other.

FIG. 3 is an enlargement of the vicinity of electrodes 7 and 8 according to Embodiment 1 of the present invention. In this case, since the recess portion 8a is disposed in a central portion of a contact surface of the movable electrode 8, a welding imprint 13b is generated on a single side so as to be radially offset from a central axis. Since the release force F2 in this case functions as an offset load relative to the welding surface, release is possible with a force smaller than F1. This is possible even if the actuator mechanism of the circuit breaker is of low strength, making the circuit breaker economical.

Now, if a recess portion is disposed in a central portion of the contact surfaces of both the fixed electrode 7 and the movable electrode 8, the release force is low because a welding imprint is generated on a single side so as to be radially offset from a central axis, but in that case, when the electrodes 7 and 8 are off center due to the gaps between the guide 12 and the movable electrode rod 5, the mutual contact surface area is reduced, and as a result one problem is that contact resistance may be higher, simultaneously increasing the wear rate of the electrodes 7 and 8 due to switching of the load current.

However, with the combination of shapes of the electrodes 7 and 8 according to Embodiment 1, since the contact surface of a single electrode (the fixed electrode 7) is a flat plane, the surface area is large, and since a stable contact surface is achieved on the fixed electrode 7, contact resistance due to contact between the two electrodes 7 and 8 is low and stable, effectively reducing the wear rate of the electrodes 7 and 8, and hence, a high-performance vacuum valve can be achieved by an economical technique.

Embodiment 2

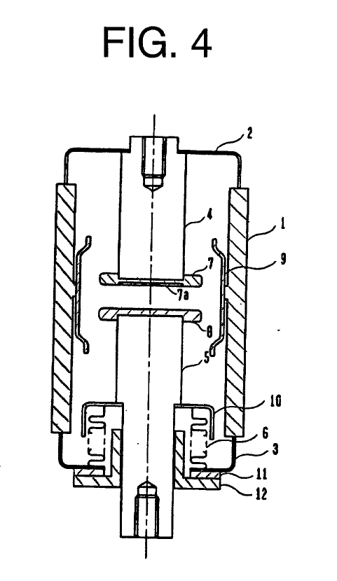

FIG. 4 is a cross section showing a vacuum valve according to Embodiment 2 of the present invention.

In FIG. 4, a recess portion 7a is disposed in a central portion of the contact surface of the fixed electrode 7.

Next, the electrical performance of the vacuum valve according to Embodiment 2 will be explained.

First, performance during short-circuit current interruption will be explained.

The ability to interrupt a short-circuit current is determined by whether or not the withstand voltage between the electrodes 7 and 8 can withstand the recovery voltage after electric-current interruption, and if the temperature of the electrodes 7 and 8 is locally high, restriking occurs easily at that position, leading to interruption failure.

In FIG. 4, since the electrode shield 9 is supported in a substantially central portion of the electrically-insulating tube 1, the electric potential of the electrode shield 9 is determined by the capacity between the electrode shield 9 and the fixed electrode rod 4, the fixed electrode 7, the movable electrode rod 5, and the movable electrode 8, and since the electric potential of the electrode shield 9 is close to the intermediate electric potential between the fixed electrode 7 and the movable electrode 8, the electric field in peripheral portions of the electrodes 7 and 8 is moderated.

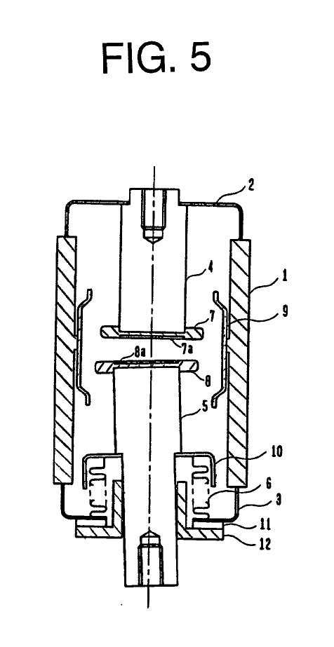

FIG. 5 is an example of a vacuum valve in which the recess portions 7a and 8a are formed in the central portion of the contact surfaces of both the fixed and movable electrodes 7 and 8, and in this case, a decline in interrupting performance was observed compared to when there was no recess portion 7a or 8a at all. As a result of inspection of the surface of the electrodes 7 and 8 after interruption, it was found that damage to the movable electrode 8 was intense and that the movable electrode 8 was a cause of interruption failure. This is due to the following reasons:

1) When the electrodes 7 and 8 both have recess portions 7a and 8a, local temperature increases arise easily during large-current interruption because the electric field value at corner portions of the recess portions 7a and 8a is more likely to be high and spreading of the electric arc is poor compared to flat contact surfaces, making large-current interrupting performance more likely to decline than that of flat contact surfaces; and

2) As shown in FIG. 5, tilting arises in the movable electrode 8 as part of the movement during actual contact breaking due to the gaps between the guide 12 and the movable electrode rod 5, and as a result the distance between the movable electrode 8 and the electrode shield 9 narrows, resulting in the electric field value of the movable electrode 8 becoming even higher.

In the vacuum valve according to Embodiment 2, the recess portion 7a is disposed only in a central portion of the contact surface of the fixed electrode 7, the movable electrode 8 being a flat shape having no recess portion 8a. As a result of large-current interruption tests, good performance was displayed, and this is considered to be due to the following reasons:

1) Local electric-field convergence is eliminated because there is no recess portion 8a in the movable electrode 8, local temperature increases are prevented because the electric arc spreads easily, and although there is deterioration in the electric field due to proximity to the electrode shield 9, this does not lead to restriking; and

2) Because the recess portion 7a is disposed in the fixed electrode 7, spreading of the electric arc is slightly poor and the electric field value is higher in corner portions due to the recess portion 7a, but since the distance from the electrode shield 9 is kept uniform, the electric field of the fixed electrode 7 does not deteriorate, instead forming a balanced construction.

The good large-current interrupting performance is considered to have been achieved due to the above reasons.

Embodiment 3

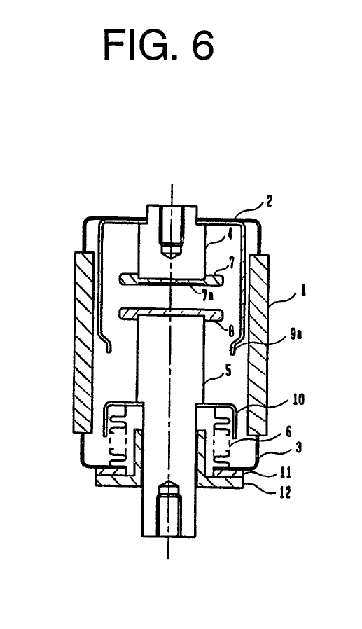

FIG. 6 is a cross section showing a vacuum valve according to Embodiment 3 of the present invention.

In FIG. 6, a fixed-end shield 9a is mounted to the fixed-end end plate 2, and the recess portion 7a is disposed in a central portion of the contact surface of the fixed electrode 7. This fixed-end shield 9a prevents the inner wall surface of the electrically-insulating tube 1 from being polluted by a metallic vapor generated by the fixed electrode 7 and the movable electrode 8 during electric-current interruption.

Next, the electrical performance of the vacuum valve according to Embodiment 3 will be explained.

In FIG. 6, the fixed-end shield 9a is mounted to the fixed-end end plate 2. Characteristics of the vacuum valve having this configuration include the fact that stepped portions and auxiliary fittings required when a shield is mounted to an electrically-insulating tube 1 constituted by a ceramic are no longer necessary, enabling the axial length of the electrically-insulating tube 1 to be shortened, but on the other hand, since the electric potential of the fixed-end shield 9a is the same as the electric potential of the fixed electrode 7, the electric field becomes restrictive in the vicinity of the movable electrode 8, necessitating use thereof with comparatively low working voltages.

In this embodiment of the present invention, the recess portion 7a is disposed in a central portion of the contact surface of the fixed electrode 7 and the contact surface of the movable electrode 8 is flat, avoiding deterioration of the electric field due to the recess portion, and a welding imprint is generated on a single side offset radially from the central axis without decreasing large-current interruption performance, thereby enabling the weld release force to be lowered.

Embodiment 4

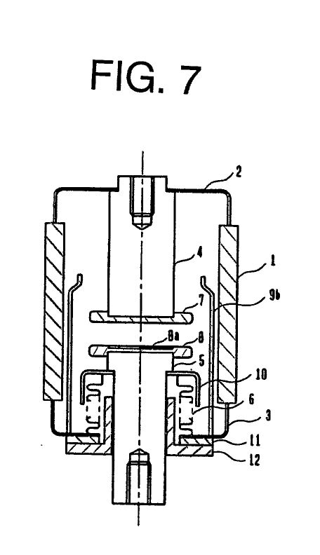

FIG. 7 is a cross section showing a vacuum valve according to Embodiment 4 of the present invention.

In FIG. 7, a moving-end shield 9b is mounted to the moving-end end plate 3, and the recess portion 8a is disposed in a central portion of the contact surface of the movable electrode 8. The moving-end shield 9b prevents the inner wall surface of the electrically-insulating tube 1 from being polluted by a metallic vapor generated by the fixed electrode 7 and the movable electrode 8 during electric-current interruption.

In this embodiment of the present invention, the electric potential of the moving-end shield 9b is the same as the electric potential of the movable electrode 8, and the recess portion 8a is disposed in a central portion of the contact surface of the movable electrode 8 and the contact surface of the fixed electrode 7 is flat, avoiding deterioration of the electric field due to the recess portion, and a welding imprint is generated on a single side offset radially from the central axis without decreasing large-current interruption performance, thereby enabling the weld release force to be lowered.

As explained above, according to one aspect of the present invention, there is provided a vacuum valve including:

a vacuum vessel having an interior portion sealed by a fixed-end end plate and a moving-end end plate disposed at first and second end portions, respectively, of a cylindrical electrically-insulating tube;

a fixed electrode rod secured to the fixed-end end plate, a fixed electrode being disposed on an end portion of the fixed electrode rod;

a movable electrode rod, a movable electrode capable of contacting and separating from the fixed electrode being disposed on an end portion of the movable electrode rod; and

an electrode shield secured to the electrically-insulating tube and enveloping the fixed electrode and the movable electrode, the electrode shield preventing an inner wall surface of the electrically-insulating tube from being polluted by a metallic vapor generated by the fixed electrode and the movable electrode during electric-current interruption,

a recess portion being formed in a central portion of only one of either a contact surface of the movable electrode or a contact surface of the fixed electrode, whereby a welding imprint is generated on a single side offset radially from the central axis, enabling weld release by a small force, and enabling a high-performance, low-cost vacuum valve to be provided in which contact resistance is stable and low and the electrode wear rate is reduced.

In the vacuum valve according to the present invention, the recess portion may be formed only on the fixed electrode, whereby, although a portion arises in the fixed electrode in which the electric field value is high, the distance from the electrode shield is kept uniform and the electric field of the fixed electrode does not deteriorate, enabling weld release by a small force, and enabling a high-performance, low-cost vacuum valve to be provided in which contact resistance is stable and low and the electrode wear rate is reduced.

According to another aspect of the present invention, there is provided a vacuum valve including:

a vacuum vessel having an interior portion sealed by a fixed-end end plate and a moving-end end plate disposed at first and second end portions, respectively, of a cylindrical electrically-insulating tube;

a fixed electrode rod secured to the fixed-end end plate, a fixed electrode being disposed on an end portion of the fixed electrode rod;

a movable electrode rod, a movable electrode capable of contacting and separating from the fixed electrode being disposed on an end portion of the movable electrode rod; and

a fixed-end shield secured to the fixed-end end plate and enveloping the fixed electrode and the movable electrode, the fixed-end shield preventing an inner wall surface of the electrically-insulating tube from being polluted by a metallic vapor generated by the fixed electrode and the movable electrode during electric-current interruption,

a recess portion being formed in a central portion of only a contact surface of the fixed electrode, whereby a welding imprint is generated on a single side offset radially from the central axis, enabling weld release by a small force, and enabling a high-performance, low-cost vacuum valve to be provided in which contact resistance is stable and low and the electrode wear rate is reduced.

According to yet another aspect of the present invention, there is provided a vacuum valve including:

a vacuum vessel having an interior portion sealed by a fixed-end end plate and a moving-end end plate disposed at first and second end portions, respectively, of a cylindrical electrically-insulating tube;

a fixed electrode rod secured to the fixed-end end plate, a fixed electrode being disposed on an end portion of the fixed electrode rod;

a movable electrode rod, a movable electrode capable of contacting and separating from the fixed electrode being disposed on an end portion of the movable electrode rod; and

a moving-end shield secured to the moving-end end plate and enveloping the fixed electrode and the movable electrode, the moving-end shield preventing an inner wall surface of the electrically-insulating tube from being polluted by a metallic vapor generated by the fixed electrode and the movable electrode during electric-current interruption,

a recess portion being formed in a central portion of only a contact surface of the movable electrode, whereby a welding imprint is generated on a single side offset radially from the central axis, enabling weld release by a small force, and enabling a high-performance, low-cost vacuum valve to be provided in which contact resistance is stable and low and the electrode wear rate is reduced.

What is claimed is:

1. A vacuum valve comprising:
a vacuum vessel having an interior portion sealed by a fixed-end end plate and a moving-end end plate disposed at first and second end portions, respectively, of a cylindrical electrically-insulating tube;
a fixed electrode rod secured to said fixed-end end plate, a fixed electrode being disposed on an end portion of said fixed electrode rod;
a movable electrode rod, a movable electrode capable of contacting and separating from said fixed electrode being disposed on an end portion of said movable electrode rod; and
an electrode shield secured to said electrically-insulating tube and enveloping said fixed electrode and said movable electrode, said electrode shield preventing an inner wall surface of said electrically-insulating tube from being polluted by a metallic vapor generated by said fixed electrode and said movable electrode during electric-current interruption,
a recess portion being formed in a central portion of only one of either a contact surface of said movable electrode or a contact surface of said fixed electrode.

2. The vacuum valve according to claim 1 wherein said recess portion is formed only on said fixed electrode.

3. A vacuum valve comprising:
a vacuum vessel having an interior portion sealed by a fixed-end end plate and a moving-end end plate disposed at first and second end portions, respectively, of a cylindrical electrically-insulating tube;
a fixed electrode rod secured to said fixed-end end plate, a fixed electrode being disposed on an end portion of said fixed electrode rod;
a movable electrode rod, a movable electrode capable of contacting and separating from said fixed electrode being disposed on an end portion of said movable electrode rod; and
a fixed-end shield secured to said fixed-end end plate and enveloping said fixed electrode and said movable electrode, said fixed-end shield preventing an inner wall surface of said electrically-insulating tube from being polluted by a metallic vapor generated by said fixed electrode and said movable electrode during electric-current interruption,
a recess portion being formed in a central portion of only a contact surface of said fixed electrode.

4. A vacuum valve comprising:
a vacuum vessel having an interior portion sealed by a fixed-end end plate and a moving-end end plate disposed at first and second end portions, respectively, of a cylindrical electrically-insulating tube;
a fixed electrode rod secured to said fixed-end end plate, a fixed electrode being disposed on an end portion of said fixed electrode rod;
a movable electrode rod, a movable electrode capable of contacting and separating from said fixed electrode being disposed on an end portion of said movable electrode rod; and
a moving-end shield secured to said moving-end end plate and enveloping said fixed electrode and said movable electrode, said moving-end shield preventing an inner wall surface of said electrically-insulating tube from being polluted by a metallic vapor generated by said fixed electrode and said movable electrode during electric-current interruption,
a recess portion being formed in a central portion of only a contact surface of said movable electrode.
